(19) United States
(12) Patent Application Publication
(10) Pub. No.: US 2026/0044278 A1
(43) Pub. Date: Feb. 12, 2026

(54) BALANCING PEC IN MEMORY SYSTEMS

(71) Applicant: Micron Technology, Inc., Boise, ID (US)

(72) Inventors: Donghua Zhou, Suzhou City (CN); Meng Wei, Shanghai (CN); Yue Wei, Shanghai (CN); Guang Shen, Shanghai (CN)

(21) Appl. No.: 19/100,418

(22) PCT Filed: Aug. 2, 2022
(86) PCT No.: PCT/CN2022/109619

§ 371 Date: Jan. 31, 2025

(51) Int. Cl. G06F 3/06

(52) U.S. Cl. CPC G06F 3/0652; G06F 3/0604; G06F 3/0679

(57) ABSTRACT

Aspects of the present disclosure configure a memory sub-system controller, to balance PEC across dies/planes of a memory sub-system. The memory sub-system controller determines that a first PEC of a first portion of a set of memory components is smaller than a second lifetime PEC of a second portion of the set of memory components. The memory sub-system controller performs a first memory operation on the first and second portions in response to a first request associated with the block stripe. The memory sub-system controller erases the block stripe comprising the first and second portions. The memory sub-system controller performs a second memory operation on the second portion of the set of memory components without performing the second memory operation on the first portion of the set of memory components in response to a second request associated with the block stripe.

### TECHNICAL FIELD

Embodiments of the disclosure relate generally to memory sub-systems and, more specifically, to providing adaptive media management for memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some embodiments of the present disclosure.

FIG. 2 is a block diagram of an example media operations manager, in accordance with some implementations of the present disclosure.

FIG. 3 is a block diagram of an example plane selection operation, in accordance with some implementations of the present disclosure.

FIG. 4 is a block diagram of an example plane selection table, in accordance with some implementations of the present disclosure.

FIG. 5 is a flow diagram of an example method to perform PEC balancing, in accordance with some implementations of the present disclosure.

FIG. 6 is a block diagram illustrating a diagrammatic representation of a machine in the form of a computer system within which a set of instructions can be executed for causing the machine to perform any one or more of the methodologies discussed herein, in accordance with some embodiments of the present disclosure.

### DETAILED DESCRIPTION

Aspects of the present disclosure configure a system component, such as a memory sub-system controller, to perform program-erase count (PEC) balancing operations. The memory sub-system controller can determine the lifetime PEC of each of component of a set of memory components, such as memory dies. Based on the lifetime PEC, the memory sub-system controller can selectively distribute memory operations on across the memory components, such that at one point in time a first portion with the smaller lifetime PEC than a second portion is programmed together with the second portion and, at a later point in time, the first portion with the smaller PEC is not programmed while the second portion is programmed. This ensures that performance of the memory system remains optimal by increasing current PECs of different memory components at different rates until the PECs of the memory components reach a balance (e.g., are equal to each other or correspond to a target PEC). At that point, the different components are always programmed and erased together. This improves the overall efficiency of operating the memory sub-system.

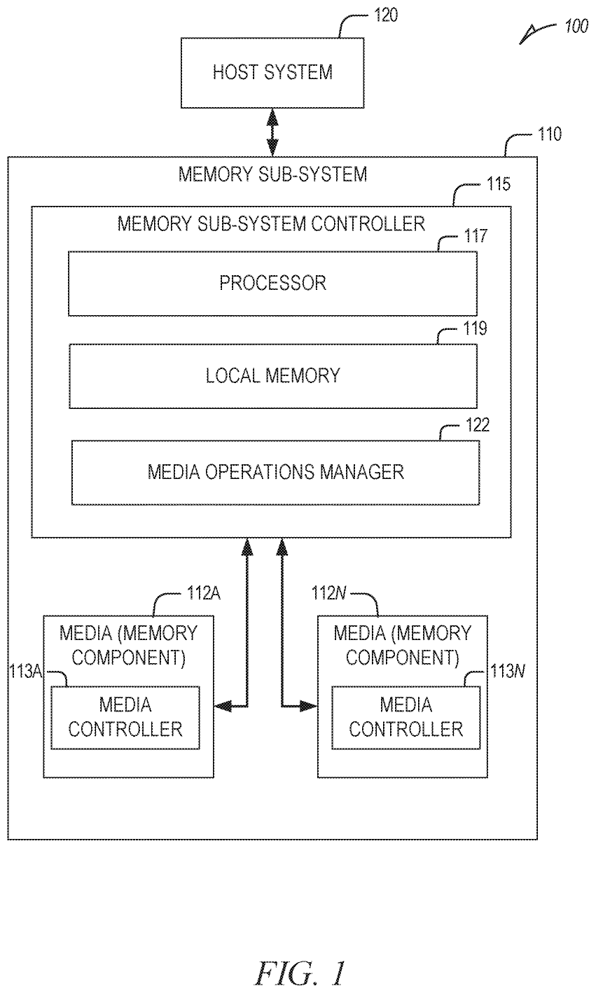

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data”. “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area than can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

There are challenges in efficiently managing or performing media management operations on typical memory devices. Specifically, certain memory devices, such as NAND flash devices, include large die-by-die reliability (RWB) variation. As the technology for such memory devices continues to be scaled down, this die-by-die reliability variation becomes more pronounced and problematic in performing memory management. Current memory systems (e.g., SSD drive or die package systems) associate all of the memory devices or memory dies in the memory system with a certain reliability specification. In some cases, each block of each memory device is associated with a reliability grade or specification which is used to determine whether the block is a good block or a bad block. Good blocks are those that have reliability grades above a reliability threshold and bad blocks are blocks that have reliability grades below a reliability threshold. The reliability grades can be set at manufacture or during operation of the memory devices, such as by measuring the data retention and/or error rate associated with particular blocks.

Certain memory systems assign, at manufacture, lifetime PEC to each block or memory die of the memory sub-system. This lifetime PEC represents the total number of times each memory die can be erased and programmed before the reliability of the memory die falls below the reliability threshold at which point the memory die can no longer be used. In some cases, once the lifetime PEC of a memory die is reached, the memory sub-system discontinues programming that memory die which effectively reduces the overall storage capacity of the memory sub-system. Memory systems maintain a current count of the PEC for each memory die and increment such a count each time all of the planes of the memory die are erased and/or programmed.

Typical memory systems leverage superblocks or block stripes (BS) which are a collection of blocks across memory planes and/or dies. Namely, each superblock can be of equal size and can include a respective collection of blocks across multiple planes and/or dies. The superblocks, when allocated, allow a controller to simultaneously write data to a large portion of memory spanning multiple blocks (across multiple planes and/or dies) with a single address. Sometimes, superblocks include memory dies that are associated with different lifetime PEC values. Typical systems program these superblocks without regard to the PEC values of the memory dies. This usually results in poor memory performance as performing memory operations on a first set of planes or dies that have lower lifetime PEC values at the same rate as a second set of planes or dies that have higher lifetime PEC values can result in the first set of planes being discontinued from use before the second set of planes which can reduce the overall storage capacity of the memory sub-system. As such, applying a one-size-fits-all approach to memory systems that have a mix of PEC values for different superblock portions is inefficient and results in poor or unreliable memory performance.

Aspects of the present disclosure address the above and other deficiencies by providing a memory controller that can balance the PEC across different memory components, such as planes, of multiple memory dies implementing a block stripe. This ensures that the different memory components reach a target PEC at the same time rather than the lifetime PEC of one set of components being depleted or reached before the lifetime PEC of another set of components. This ensures that performance of the memory system remains optimal by increasing current PECs of different memory components at different rates until the PECs of the memory components reach a balance (e.g., are equal to each other or correspond to a target PEC). At that point, the different components are always programmed and erased together. This improves the overall efficiency of operating the memory sub-system.

For example, the memory controller can determine that a first lifetime program-erase count (PEC) of a first portion of the set of memory components is smaller than a second lifetime PEC of a second portion of the set of memory components. The memory controller can perform a first memory operation on the first and second portions of the set of memory components in response to a first request associated with the block stripe and erase the block stripe that includes the first and second portions of the set of memory components after performing the first memory operation. The memory controller can, after erasing the block stripe, perform a second memory operation on the second portion of the set of memory components without performing the second memory operation on the first portion of the set of memory components in response to a second request associated with the block stripe.

In some examples, the first and second memory operations include writing (programming or erasing) respective sets of data to the block stripe.

In some examples, the memory controller accesses configuration data comprising a lifetime PEC of each of the set of memory components. The first portion of the set of memory components can include a first memory die and the second portion of the set of memory components can include a second memory die.

In some cases, the first portion of the set of memory components includes a set of planes of a plurality of planes of a first memory die and the second portion of the set of memory components includes a second memory die. In some examples, the set of planes is a first set of planes. In such cases, the memory controller programs the first set of planes in response to the first request associated with the block stripe without programming a second set of planes of the plurality of planes of the first memory die. The memory controller programs the second set of planes in response to the second request associated with the block stripe without programming the first set of planes.

In some examples, the memory controller alternates between selecting the first set of planes and selecting the second set of planes for being programmed in response to each subsequent request associated with the block stripe. Specifically, the first portion of the set of memory components can include a set of planes of a quantity of planes. In such cases, the memory controller selects a target PEC for the set of memory components and forms the set of planes as a function of the target PEC, the quantity of planes, the first lifetime PEC of the first portion, and the second lifetime PEC of the second portion. For example, the set of planes can be formed in accordance with the function comprising:

$$set of planes count = PC * \frac{PEC of the first portion - the target PEC}{PEC of the second portion - the target PEC} ,$$

where the set of planes count represents how many planes are in the set of planes, PC corresponds to the quantity of planes, the PEC of the first portion corresponds to the first lifetime PEC, and the PEC of the second portion corresponds to the second lifetime PEC.

In some examples, the memory controller can reduce the first lifetime PEC at a different rate than the second lifetime PEC in response to the first and second requests, such as by incrementing a current PEC of each memory component relative to the corresponding lifetime PEC of the memory component.

In some cases, the memory controller can select a plane count associated with the first portion and computes, based on the plane count, a target PEC representing a remaining quantity of PEC of the first and second portions after completing balancing the first lifetime PEC with the second lifetime PEC. The target PEC can be computed in accordance with:

$$target PEC = \frac{\begin{matrix}PEC of first portion * Total Plane Count - \\ PEC of second portion * Plane Count Selected\end{matrix}}{Total Plane Count - Plane Count} ,$$

where the PEC of the first portion corresponds to the first lifetime PEC, the PEC of the second portion corresponds to the second lifetime PEC, and the total plane count represents a quantity of planes in a memory die comprising the first portion.

In some examples, the memory controller can select a target PEC for the set of memory components. The memory controller can compute a plurality of quantities of planes to select from a set of planes of each memory die of a plurality of memory dies as a function of the target PEC, a total quantity of planes in the set of planes, the first lifetime PEC of the first portion, and the second lifetime PEC of the second portion. The memory controller can determine a scaling factor for each of the plurality of quantities of planes and generate a plurality of plane selection tables based on the plurality of quantities of planes and the scaling factors, a first plane selection table of the plurality of plane selection tables corresponding to a first memory die of the plurality of memory dies, a second plane selection table of the plurality of plane selection tables corresponding to a second memory die of the plurality of memory dies.

In some cases, the first plane selection table includes a first list of sequential times corresponding to the scaling factor of a first quantity of the plurality of quantities, each sequential time in the first list of sequential times being associated with identifiers of the planes selected from the set of planes of the first memory die. The second plane selection table includes a second list of sequential times corresponding to the scaling factor of a second quantity of the plurality of quantities, each sequential time in the second list of sequential times being associated with identifiers of the planes selected from the set of planes of the second memory die, the first and second lists of sequential times having different quantities of sequential times.

In some examples, the memory controller obtains a current PEC associated with the second portion of the set of memory components and divides the current PEC by the scaling factor of the first quantity of the plurality of quantities of the first die to identify a remainder. The memory controller can identify an individual sequential time within the first plane selection table corresponding to the remainder. In some cases, the memory controller retrieves the identifiers of the planes selected from the set of planes of the first memory die corresponding to the individual sequential time and performs the first memory operation on a first subset of planes of the first memory die corresponding to the retrieved identifiers of the planes selected from the set of planes without performing the first memory operation on a second subset of planes of the first memory die.

In some examples, the memory controller can determine that a first current PEC of the first portion corresponds to a second current PEC of the second portion. In response to determining that the first current PEC corresponds to the second current PEC, the memory controller discontinues balancing of the first lifetime PEC with the second lifetime PEC. Specifically, the memory controller can discontinue balancing by performing each of a plurality of memory operations received after the first current PEC corresponds to the second current PEC on the first and second portions of the set of memory components.

Though various embodiments are described herein as being implemented with respect to a memory sub-system (e.g., a controller of the memory sub-system), some or all of the portions of an embodiment can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies). Each memory die can include a plurality of planes in which data can be stored or programmed.

In some examples, the first memory component 112A, block, or page of the first memory component 112A, or group of memory components including the first memory component 112A can be associated with a first reliability (capability) grade, value, measure, or lifetime PEC. The terms “reliability grade,” “value” and “measure” are used interchangeably throughout and can have the same meaning. The second memory component 112N or group of memory components including the second memory component 112N can be associated with a second reliability (capability) grade, value, measure, or lifetime PEC. In some examples, each memory component 112A to 112N can store respective configuration data that specifies the respective reliability grade and lifetime PEC and current PEC. In some examples, a memory or register can be associated with all of the memory components 112A to 112N which can store a table that maps different groups, bins or sets of the memory components 112A to 112N to respective reliability grades, lifetime PEC values, and/or current PEC values.

In some examples, a memory or register can be associated with all of the memory components 112A to 112N which can store a table that maps pages across all of the memory components 112A to 112N that are associated with an individual block stripe. Specifically, a block or set of pages within the first memory component 112A can be grouped with a block or set of pages within the second memory component 112N to form a superblock or block stripe. Superblocks (or block stripes) can be addressed collectively using a single address. In such cases, an LTP table can store the association between the single address and each of the blocks or sets of pages of the first memory component 112A and second memory component 112N associated with that single address. In some embodiments, a first set of the blocks or pages of the superblock (or block stripe) implemented by the first memory component 112A can be associated with a first lifetime PEC and a second set of the blocks or pages of the superblock (or block stripe) implemented by the second memory component 112N can be associated with a second lifetime PEC. The second lifetime PEC can be greater or larger than the first lifetime PEC.

In some cases, the media operations manager 122 balances operations performed with respect to such block stripes to cause the first set of blocks or pages to reach a target PEC at the same time as the second set of blocks or pages. To do so, the media operations manager 122 can perform media operations, such as program and/or erase operations, on the first set of blocks or pages at a different rate than the second set of blocks or pages. For example, the media operations manager 122 can, at a first point in time, program a first group of the first set of blocks or pages of the first memory component 112A without programing a second group of the first set of blocks or pages of the first memory component 112A while also programming the second set of blocks or pages of the second memory component 112N. At a later second point in time, the media operations manager 122 can program the second group of the first set of blocks or pages of the first memory component 112A without programing the first group of the first set of blocks or pages of the first memory component 112A while still also programming the second set of blocks or pages of the second memory component 112N. As a result, a PEC value associated with the second memory component 112N can be incremented twice (once for each of the first and second points in time) while the PEC value associated with the first memory component 112A is only incremented once (after both the first and second groups of the first set of blocks or pages of the first memory component 112A have been programmed after the first and second points in time).

In some embodiments, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some embodiments, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. For example, a single first row that spans a first set of the pages or blocks of the memory components 112A to 112N can correspond to or be grouped as a first block stripe and a single second row that spans a second set of the pages or blocks of the memory components 112A to 112N can correspond to or be grouped as a second block stripe.

The memory sub-system controller 115 can communicate with the memory components 112A to 112N to perform memory operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management, different near miss ECC operations, and/or different dynamic data refresh.

The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another embodiment of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N. The configuration data can describe the lifetime PEC values and/or reliability grades associated with different groups of the memory components 112N to 112N and/or different blocks within each of the memory components 112N to 112N.

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some embodiments, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to balance the PEC across different memory components 112A to 112N, such as planes, of multiple memory dies implementing a block stripe. This ensures that the different memory components 112A to 112N reach a target PEC at the same time rather than the lifetime PEC of one set of components 112A being depleted or reached before the lifetime PEC of another set of components 112N. This ensures that performance of the memory system remains optimal by increasing current PECs of different memory components 112A to 112N at different rates until the PECs of the memory components 112A to 112N reach a balance (e.g., are equal to each other or correspond to a target PEC). At that point, the different components 112A to 112N are always programmed and erased together. This improves the overall efficiency of operating the memory sub-system 110.

Depending on the embodiment, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

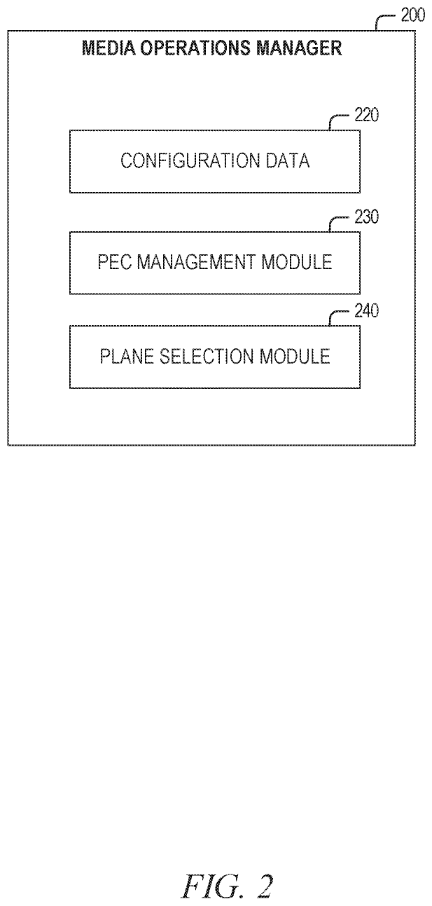

FIG. 2 is a block diagram of an example media operations manager 200 (corresponding to media operations manager 122), in accordance with some implementations of the present disclosure. As illustrated, the media operations manager 200 includes configuration data 220, a PEC management module, and a plane selection module 240. Any discussion with respect to plane selection can be similarly applied to block and/or memory die selection. For some embodiments, the media operations manager 200 can differ in components or arrangement (e.g., less or more components) from what is illustrated in FIG. 2.

The configuration data 220 accesses and/or stores configuration data associated with the memory components 112A to 112N. In some examples, the configuration data 220 is programmed into the media operations manager 200. For example, the media operations manager 200 can communicate with the memory components 112A to 112N to obtain the configuration data and store the configuration data 220 locally on the media operations manager 122. In some examples, the media operations manager 122 communicates with the host system 120. The host system 120 receives input from an operator or user that specifies parameters including lifetime PEC values of different bins, groups, blocks, block stripes, memory dies and/or sets of the memory components 112A to 112N. The media operations manager 122 receives configuration data from the host system 120 and stores the configuration data in the configuration data 220.

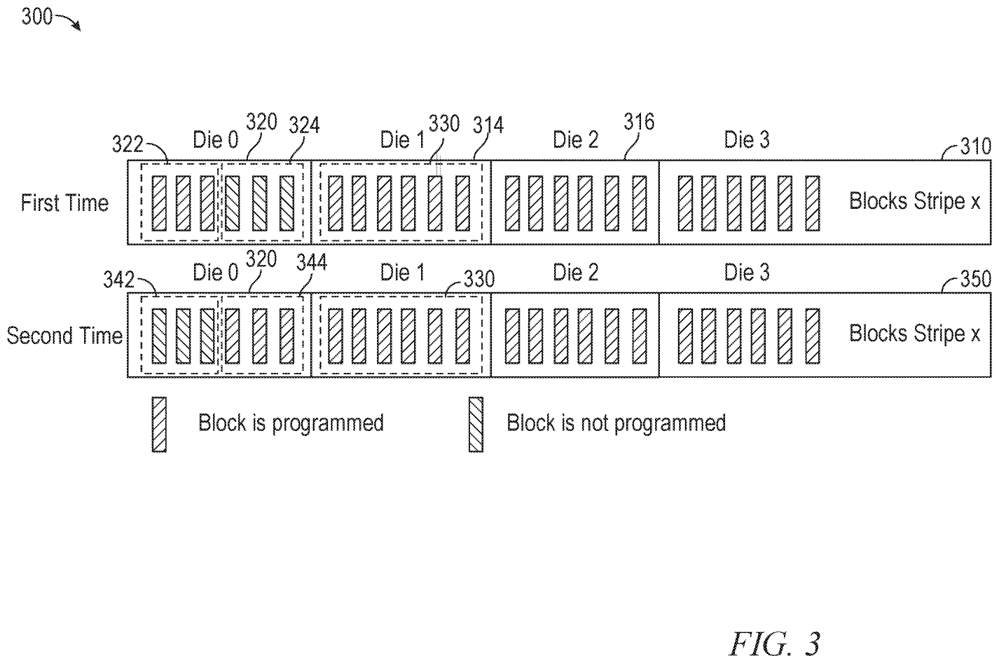

The PEC management module 230 can access the configuration data 220 to determine that a first lifetime PEC of a first portion of the set of memory components 112A is smaller than a second lifetime PEC of a second portion of the set of memory components 112N. For example, as shown in the illustrative block stripe 300 of FIG. 3, the PEC management module 230 identifies a plurality of memory dies including a first memory die 320, a second memory die 314, and a third memory die 316 of an individual block stripe 300. The first memory die 320 can be associated with a first lifetime PEC, the second memory die 314 can be associated with a second lifetime PEC, and the third die 316 can be associated with a third lifetime PEC. The first, second and third lifetime PEC values can all be the same or can differ in part from one another in various combinations.

The PEC management module 230 can perform a first memory operation on the first and second portions of the set of memory components in response to a first request associated with the block stripe and erases the block stripe that includes the first and second portions of the set of memory components after performing the first memory operation. The memory controller can, after erasing the block stripe, perform a second memory operation on the second portion of the set of memory components without performing the second memory operation on the first portion of the set of memory components in response to a second request associated with the block stripe.

Specifically, the PEC management module 230 determines that the first lifetime PEC of the first memory die 320 is smaller than the second lifetime PEC of the second memory die 314. In such cases, the PEC management module 230 selectively programs different groups of planes of the first memory die 320 based on certain plane selection criteria. Specifically, in response to receiving a first request to write data to the block stripe 300, the PEC management module 230 communicates with the plane selection module 240 to identify and select which individual groups of planes of the first memory die 320 to program and/or erase at a given time or cycle corresponding to the first request. For example, the PEC management module 230 can alternate between programming a first group of planes 322 and a second group of planes 324 at different points in time. Namely, at a first point in time 310, the PEC management module 230 can select the first group of planes 322 to program together with the planes 330 of the second memory die 314 and planes of the third memory die 316. In such cases, the PEC management module 230 prevents programming the second group of planes 324 while the first group planes 322 are being programmed together with the planes 330 of the second memory die 314 and planes of the third memory die 316. At this point, the PEC management module 230 updates or increments a current PEC value associated with the second memory die 314 and the third memory die 316 but does not yet update or increment the current PEC value associated with the first memory die 320. This is because not all of the planes of the first memory die 320 have been programmed up to this point (e.g., the second group of planes 324 have not yet been programmed). Namely, the current PEC value represents a cycle at which each of the planes of a given memory die has been programmed and/or erased.

At a later point in time, the PEC management module 230 can perform garbage collection and can erase all of the planes to which data has been written of the block stripe 300. At a second point in time 350, a second request to write data to the block stripe 300 is received. In response, the PEC management module 230 communicates with the plane selection module 240 to identify and select another individual group of planes of the first memory die 320 to program and/or erase. For example, the PEC management module 230 can, at the second point in time 350, select the second group of planes 344 to program together with the planes 330 of the second memory die 314 and planes of the third memory die 316. In such cases, the PEC management module 230 prevents programming the first group of planes 342 while the second group planes 344 are being programmed together with the planes 330 of the second memory die 314 and planes of the third memory die 316. At this point, the PEC management module 230 again updates or increments a current PEC value associated with the second memory die 314 and the third memory die 316 (e.g., because all of their planes have been written to in the second point in time 350).

In some cases, the PEC management module 230 determines that now all of the planes of the first memory die 320 have been programmed and so the PEC management module 230 updates or increments the current PEC value associated with the first memory die 320. As such, after the first point in time 310 and the second point in time 350, the current PEC value of the second memory die 314 and the third memory die 316 has been updated or incremented two times whereas the current PEC value of the first memory die 320 has been incremented one time. Continuing with these operations of alternating the plane selection and incrementing the PEC values of different memory dies at different rates eventually balances the PEC values of the block stripe 300. In this way, after a threshold quantity of times or a threshold quantity of requests to write or program data into the block stripe 300 are received, the current PEC values of the first memory die 320 will correspond to or equal the current PEC values of the second memory die 314 and the third memory die 316. At that point, the PEC management module 230 programs and/or erases all of the planes (e.g., the first group of planes 322 and the second group of planes 324) together with the planes 330 of the second memory die 314 and the planes of the third memory die 316. In this way, all of the memory dies associated with the block stripe 300 will eventually reach their respective lifetime PEC at the same time.

In some cases, rather than selecting particular groups of planes of an individual memory die to write at different points in time, the PEC management module 230 can alternate or skip programming and/or erasing the individual memory altogether. For example, at the first point in time 310, the PEC management module 230 can program and/or erase all of the planes (e.g., the first group of planes 322 and the second group of planes 324) of the first memory die 320 together with the planes 330 of the second memory die 314 and the planes of the third memory die 316 in response to the first memory operation request. At the second point in time 350, the PEC management module 230 can skip or prevent programming and/or erasing all of the planes (e.g., the first group of planes 322 and the second group of planes 324) of the first memory die 320 while programming and/or erasing all the planes 330 of the second memory die 314 and all the planes of the third memory die 316 in response to the second memory operation request. In this way, the current PEC values of the first memory die 320, the second memory die 314 and the third memory die 316 are updated or incremented at different rates. As such, all of the memory dies associated with the block stripe 300 will eventually reach their respective lifetime PEC at the same time.

In some examples, the plane selection module 240 can select a target PEC for the set of memory components and can form a set of planes to which to provide to the PEC management module 230 as selected planes to program and/or erase as a function of the target PEC, the quantity of planes, the first lifetime PEC of the first portion, and the second lifetime PEC of the second portion. Specifically, the plane selection module 240 can form the set of planes in accordance with the following function or Equation 1:

$$set of planes count = PC * \frac{PEC of the first portion - the target PEC}{PEC of the second portion - the target PEC} ,$$

where the set of planes count represents how many planes are in the set of planes, PC corresponds to the quantity of planes, the PEC of the first portion corresponds to the first lifetime PEC, and the PEC of the second portion corresponds to the second lifetime PEC. Namely, the plane selection module 240 can receive input that selects the target PEC. The target PEC can represent the PEC that is used to balance the PEC values of different planes of a memory die. Once the target PEC is reached by all the memory dies, all of the planes of the memory dies can be programmed and/or erased at the same time.

In some examples, the plane selection module 240 can compute the target PEC based on the quantity of planes that are selected from a total number of available planes of an individual memory die to be programmed and/or erased each time a memory operation is performed in association with an individual block stripe. The quantity of planes can be selected based on configuration information and/or input form a host. The target PEC can then be computed in accordance with Equation 2:

$$target PEC = \frac{\begin{matrix}PEC of first portion * Total Plane Count - \\ PEC of second portion * Plane Count Selected\end{matrix}}{Total Plane Count - Plane Count} ,$$

where the PEC of the first portion corresponds to the first lifetime PEC, the PEC of the second portion corresponds to the second lifetime PEC, and the total plane count represents a quantity of planes in a memory die comprising the first portion.

For example, if the plane count of a given memory die, that is used each time the memory die is programmed during PEC balancing, is 3 and the total number of planes included in the given memory die is 6, then the target PEC can be computed as a function of the lifetime or current PEC value of a first memory die and the lifetime or current PEC value of a second memory die (e.g., the memory die having the larger lifetime PEC value). Specifically, the lifetime PEC value of the first memory die can be 7000 and the lifetime PEC value of the second memory die can be 10000. In such cases, the target PEC can be computed to equal 4000 (e.g., (7000*6−10000*3)/(6−3)). Namely, the PEC of the first portion corresponds to the lifetime PEC of the first memory die, the PEC of the second portion corresponds to the lifetime PEC of the second memory die, the total plane count corresponds to the total number of available planes in the memory die, and the plane count selected corresponds to the plane count of a given memory die, that is used each time the memory die is programmed during PEC balancing. Once the current PEC values of all of the memory dies reach the target PEC (at the same time or cycle), the PEC balancing operations can be terminated or stopped to having subsequent program and/or erase operations performed across all of the planes of the block stripe.

In some examples, the plane selection module 240 selects a target PEC for the set of memory components and computes a plurality of quantities of planes to select from a set of planes of each memory die of a plurality of memory dies as a function of the target PEC, a total quantity of planes in the set of planes, the first lifetime PEC of the first portion, and the second lifetime PEC of the second portion. The plane selection module 240 determines a scaling factor for each of the plurality of quantities of planes and generates a plurality of plane selection tables based on the plurality of quantities of planes and the scaling factors, a first plane selection table of the plurality of plane selection tables corresponding to a first memory die of the plurality of memory dies, a second plane selection table of the plurality of plane selection tables corresponding to a second memory die of the plurality of memory dies. The first plane selection table can include a first list of sequential times corresponding to the scaling factor of a first quantity of the plurality of quantities, each sequential time in the first list of sequential times being associated with identifiers of the planes selected from the set of planes of the first memory die. The second plane selection table can include a second list of sequential times corresponding to the scaling factor of a second quantity of the plurality of quantities, each sequential time in the second list of sequential times being associated with identifiers of the planes selected from the set of planes of the second memory die, the first and second lists of sequential times having different quantities of sequential times.

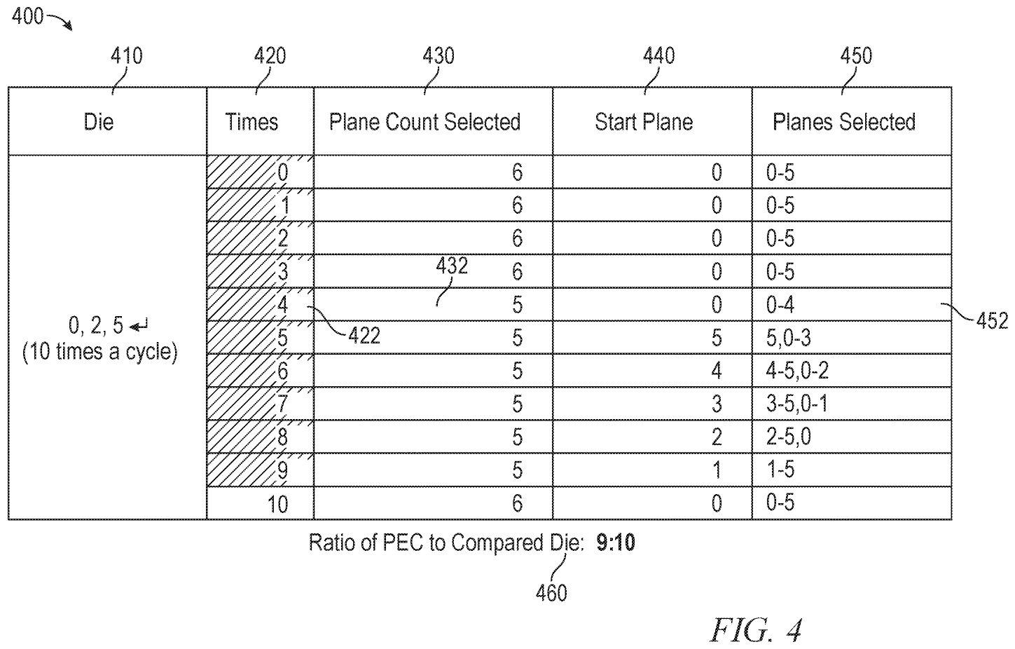

For example, FIG. 4 shows a block diagram of an example plane selection table 400 generated by the plane selection module 240, in accordance with some implementations of the present disclosure. To generate the plane selection table 400 for a first memory die or first set of memory dies, the plane selection module 240 determines the total quantity of planes available in each memory die, and the subject PEC of a particular memory die, such as the memory die of a set of memory dies that has a largest PEC value than the PEC values of all the other memory dies in the set of memory dies. The plane selection module 240 also selects a target PEC.

In accordance with Equation 1, the plane selection module 240 obtains the number of planes (PlaneCntSelected) of the total quantity of planes that can be selected in each time and for each memory die. This can be performed based on the lifetime PEC values of each memory die relative to the subject PEC of the particular memory die. In a specific example, the total quantity of planes can be 6, the subject PEC (e.g., of memory die 7) can be 11000, and the target PEC can be 1000. In such cases, the plane selection module 240 generates an initial plane count indication table shown below:

| | Die 0 | Die 1 | Die 2 | Die 3 | Die 5 | Die 6 | Die 7 |
|---|---|---|---|---|---|---|---|
| PEC | 10000 | 7000 | 10000 | 8000 | 10000 | 6000 | 11000 |
| PlaneCntSelected | 5.4 | 3.6 | 5.4 | 4.2 | 5.4 | 3 | 6 |
| Integer Factor | 10 | 10 | 10 | 10 | 10 | 2 | 1 |
| TotalPlaneCountPerTimes | 54 | 36 | 54 | 42 | 54 | 6 | 6 |

In some cases, computation of the PlaneCntSelected (representing the number of planes of the given memory die to be programmed and/or erased at each particular time the block stripe is programmed and/or erased) output by Equation 1 is non-integer in value or is an integer value that is lower than a threshold. In such cases, the plane selection module 240 applies a scaling factor (e.g., Integer Factor) to the PlaneCntSelected to generate a TotalPlaneCountPerTimes value. The scaling factor can vary between each of the memory dies. For example, the result of applying Equation 1 to memory die 0 can be 5.4 in which case a scaling factor of 10 is applied to compute the TotalPlaneCountPerTimes value of 54. As another example, the result of applying Equation 1 to memory die 6 can be 3 (which is lower than a threshold) in which case a scaling factor of 2 is applied to compute the TotalPlaneCountPerTimes value of 6.

The plane selection module 240 uses the scaling factor to control the number of times included in a list of times of each plane selection table that is generated for each corresponding memory die. Specifically, as shown in FIG. 4, the plane selection module 240 generates the plane selection table 400 corresponding to the memory dies 0, 2, 5 because they all have the same lifetime PEC values. The plane selection table 400 includes a representation of the memory dies 410 to which the plane selection table 400 corresponds. The plane selection table 400 includes a list of sequential times 420 representing different sequential times at which the same block stripe is programmed and/or erased. The quantity of sequential times 420 included in the plane selection table corresponds to the scaling factor. For example, the scaling factor used for memory dies 0, 2 and 5 can be 10 in which case the plane selection table includes a list of ten sequential times. After the block stripe is programmed and/or erased a quantity of times corresponding to the list of sequential times 420 (e.g., once the last time in the list of sequential times 420 is used to select a corresponding group of planes), the plane selection module 240 completes a cycle.

The plane selection module 240 stores in association with each time listed in the list of sequential times 420, a plane count selected value 430 indicating the quantity of planes in a set of planes selected from the total quantity of available planes of the memory dies 410. This plane count selected value 530 can be computed based on Equation 1. The plane selection module 240 stores, in association with each time listed in the list of sequential times 420, a start plane value 440 and planes selected identifiers 450. The start plane value 440 identifies which plane in the set of planes (selected to be programmed and/or erased) will be used as the first plane in an array or set of planes. The planes selected identifiers 450 represent identifiers of the set of planes that are selected to be programmed and/or erased at each corresponding time the block stripe is programmed and/or erased.

In some cases, the start plane value 440 is computed in accordance with Equation 3: StartPlane=(LastStartPlane+PlaneCntSelected) % PlaneCnt, where StartPlane represents the start plane value 440, the LastStartPlane represents the value of the start plane value 440 in an immediately preceding time in the list of sequential times 420, the PlaneCntSelected represents the number of planes of the given memory die to be programmed and/or erased at each particular time the block stripe is programmed and/or erased output by Equation 1, and the PlaneCnt (or Total Plane Count) represents a total quantity of planes in a memory die. The planes selected identifiers 450 can be computed in accordance with Equation 4: Plane=(StartPlane+offset) % PlaneCnt.

The plane selection module 240 can also compute a ratio of PEC 460 representing a ratio of the lifetime PEC of the first memory die (e.g., the memory dies 0, 2 and 5) to the second memory die (e.g., memory die 7). This represents the number of times the first memory die will be programmed and/or erased relative to the second memory die. In some examples, the plane selection module 240 prevents storing the start plane value 440 and the planes selected identifiers 450 for each memory die. Rather, the plane selection module 240 computes these values on the fly in response to identifying a particular time from the list of sequential times 420.

Specifically, the plane selection module 240 can access the current PEC value of the second memory die. Based on the current PEC value of the second memory die, the plane selection module 240 can derive or compute the specific time instance in the list of sequential times 420. The plane selection module 240 divides the current PEC value of the second memory die by the scaling factor associated with the first memory die. The plane selection module 240 can use the remainder resulting from the division as an index into the plane selection table 400, specifically to identify a given time 422 from within the list of sequential times 420. Once the given time 422 is identified, the plane selection module 240 can obtain the corresponding plane count selected value 432. Using the plane count selected value 432, the plane selection module 240 can compute the planes selected identifiers 450 using Equations 3 and 4.

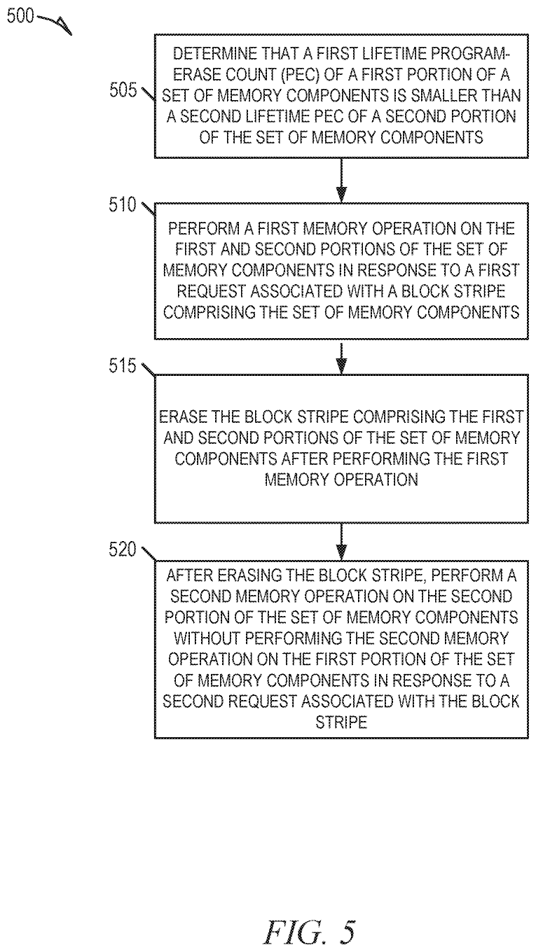

FIG. 5 is a flow diagram of an example method 500 to PEC balancing operations, in accordance with some implementations of the present disclosure. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 500 is performed by the media operations manager 122 of FIG. 1. Although the processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring now FIG. 5, the method (or process) 500 begins at operation 505, with a media operations manager 122 of a memory sub-system (e.g., memory sub-system 110) determines that a first lifetime program-erase count (PEC) of a first portion of the set of memory components is smaller than a second lifetime PEC of a second portion of the set of memory components. Then, at operation 510, the media operations manager 122 of the memory sub-system performs a first memory operation on the first and second portions of the set of memory components in response to a first request associated with the block stripe. Thereafter, at operation 515, the media operations manager 122 erases the block stripe comprising the first and second portions of the set of memory components after performing the first memory operation. The media operations manager 122, at operation 520, after erasing the block stripe, performs a second memory operation on the second portion of the set of memory components without performing the second memory operation on the first portion of the set of memory components in response to a second request associated with the block stripe.

In view of the disclosure above, various examples are set forth below. It should be noted that one or more features of an example, taken in isolation or combination, should be considered within the disclosure of this application.

Example 1: a system comprising: a set of memory components grouped into a block stripe of a memory sub-system; and a processing device operatively coupled to the set of memory components, the processing device being configured to perform operations comprising: determining that a first lifetime program-erase count (PEC) of a first portion of the set of memory components is smaller than a second lifetime PEC of a second portion of the set of memory components: performing a first memory operation on the first and second portions of the set of memory components in response to a first request associated with the block stripe: erasing the block stripe comprising the first and second portions of the set of memory components after performing the first memory operation; and after erasing the block stripe, performing a second memory operation on the second portion of the set of memory components without performing the second memory operation on the first portion of the set of memory components in response to a second request associated with the block stripe.

Example 2: the system of Example 1 wherein the first and second memory operations comprise writing respective sets of data to the block stripe.

Example 3: the system of Examples 1 or 2, wherein the operations comprise: accessing configuration data comprising a lifetime PEC of each of the set of memory components.

Example 4: the system of any one of Examples 1-3, wherein the first portion of the set of memory components comprises a first memory die, and wherein the second portion of the set of memory components comprises a second memory die.

Example 5: the system of any one of Examples 1-4, wherein the first portion of the set of memory components comprises a set of planes of a plurality of planes of a first memory die, and wherein the second portion of the set of memory components comprises a second memory die.

Example 6: the system of Example 5, wherein the set of planes is a first set of planes, and wherein the operations comprise: programming the first set of planes in response to the first request associated with the block stripe without programming a second set of planes of the plurality of planes of the first memory die; and programming the second set of planes in response to the second request associated with the block stripe without programming the first set of planes.

Example 7: the system of Example 6, wherein the operations comprise: alternating between selecting the first set of planes and selecting the second set of planes for being programmed in response to each subsequent request associated with the block stripe.

Example 8: the system of any one of Examples 1-7, wherein the first portion of the set of memory components comprises a set of planes of a quantity of planes, and wherein the operations comprise: selecting a target PEC for the set of memory components; and forming the set of planes as a function of the target PEC, the quantity of planes, the first lifetime PEC of the first portion, and the second lifetime PEC of the second portion.

Example 9: the system of Example 8, wherein the set of planes is formed in accordance with the function comprising:

$$set of planes count = PC * \frac{PEC of the first portion - the target PEC}{PEC of the second portion - the target PEC} ,$$

where the set of planes count represents how many planes are in the set of planes, PC corresponds to the quantity of planes, the PEC of the first portion corresponds to the first lifetime PEC, and the PEC of the second portion corresponds to the second lifetime PEC.

Example 10: the system of any one of Examples 1-9, wherein the operations comprise: reducing the first lifetime PEC at a different rate than the second lifetime PEC in response to the first and second requests.

Example 11: the system of any one of Examples 1-10, wherein the operations comprise: selecting a plane count associated with the first portion; and computing, based on the plane count, a target PEC representing a remaining quantity of PEC of the first and second portions after completing balancing the first lifetime PEC with the second lifetime PEC.

Example 12: the system of Example 11, wherein the target PEC is computed in accordance with:

$$target PEC = \frac{\begin{matrix}PEC of first portion * Plane Count - \\ PEC of second portion * Plane Count\end{matrix}}{Total Plane Count - Plane Count} ,$$

where the PEC of the first portion corresponds to the first lifetime PEC, the PEC of the second portion corresponds to the second lifetime PEC, and the total plane count represents a quantity of planes in a memory die comprising the first portion.

Example 13: the system of any one of Examples 1-12, wherein the operations comprise: selecting a target PEC for the set of memory components; computing a plurality of quantities of planes to select from a set of planes of each memory die of a plurality of memory dies as a function of the target PEC, a total quantity of planes in the set of planes, the first lifetime PEC of the first portion, and the second lifetime PEC of the second portion; determining a scaling factor for each of the plurality of quantities of planes; and generating a plurality of plane selection tables based on the plurality of quantities of planes and the scaling factors, a first plane selection table of the plurality of plane selection tables corresponding to a first memory die of the plurality of memory dies, a second plane selection table of the plurality of plane selection tables corresponding to a second memory die of the plurality of memory dies.

Example 14: the system of Example 13, the first plane selection table comprises a first list of sequential times corresponding to the scaling factor of a first quantity of the plurality of quantities, each sequential time in the first list of sequential times being associated with identifiers of the planes selected from the set of planes of the first memory die; and the second plane selection table comprises a second list of sequential times corresponding to the scaling factor of a second quantity of the plurality of quantities, each sequential time in the second list of sequential times being associated with identifiers of the planes selected from the set of planes of the second memory die, the first and second lists of sequential times having different quantities of sequential times.

Example 15: the system of Example 14, wherein the operations comprise: obtaining a current PEC associated with the second portion of the set of memory components; dividing the current PEC by the scaling factor of the first quantity of the plurality of quantities of the first die to identify a remainder; and identifying an individual sequential time within the first plane selection table corresponding to the remainder.

Example 16: the system of Example 15, wherein the operations comprise: retrieving the identifiers of the planes selected from the set of planes of the first memory die corresponding to the individual sequential time; and performing the first memory operation on a first subset of planes of the first memory die corresponding to the retrieved identifiers of the planes selected from the set of planes without performing the first memory operation on a second subset of planes of the first memory die.

Example 17: the system of any one of Examples 1-16, wherein the operations comprise: determining that a first current PEC of the first portion corresponds to a second current PEC of the second portion; and in response to determining that the first current PEC corresponds to the second current PEC, discontinuing balancing of the first lifetime PEC with the second lifetime PEC.

Example 18: the system of Example 17, wherein discontinuing balancing comprises performing each of a plurality of memory operations received after the first current PEC corresponds to the second current PEC on the first and second portions of the set of memory components.

Methods and computer-readable storage medium with instructions for performing any one of the above Examples.

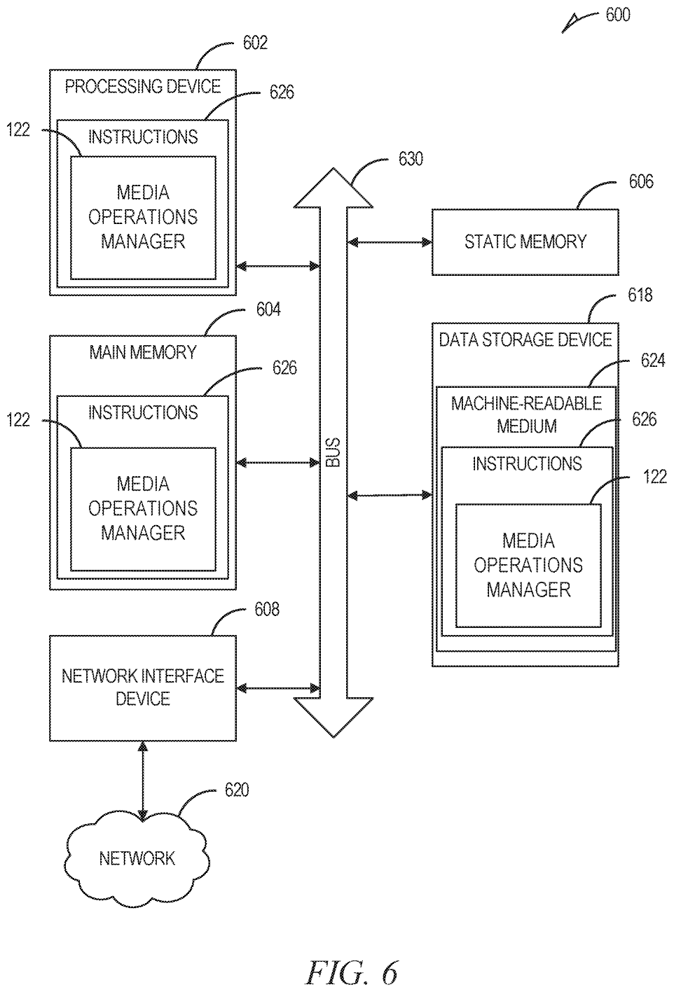

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 implement functionality corresponding to the media operations manager 122 of FIG. 1. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a set of memory components grouped into a block stripe of a memory sub-system; and
a processing device operatively coupled to the set of memory components, the processing device being configured to perform operations comprising:
determining that a first lifetime program-erase count (PEC) of a first portion of the set of memory components is smaller than a second lifetime PEC of a second portion of the set of memory components;
performing a first memory operation on the first and second portions of the set of memory components in response to a first request associated with the block stripe;
erasing the block stripe comprising the first and second portions of the set of memory components after performing the first memory operation; and
after erasing the block stripe, performing a second memory operation on the second portion of the set of memory components without performing the second memory operation on the first portion of the set of memory components in response to a second request associated with the block stripe.

2. The system of claim 1, wherein the first and second memory operations comprise writing respective sets of data to the block stripe.

3. The system of claim 1, wherein the operations comprise:
accessing configuration data comprising a lifetime PEC of each of the set of memory components.

4. The system of claim 1, wherein the first portion of the set of memory components comprises a first memory die, and wherein the second portion of the set of memory components comprises a second memory die.

5. The system of claim 1, wherein the first portion of the set of memory components comprises a set of planes of a plurality of planes of a first memory die, and wherein the second portion of the set of memory components comprises a second memory die.

6. The system of claim 5, wherein the set of planes is a first set of planes, and wherein the operations comprise:
programming the first set of planes in response to the first request associated with the block stripe without programming a second set of planes of the plurality of planes of the first memory die; and
programming the second set of planes in response to the second request associated with the block stripe without programming the first set of planes.

7. The system of claim 6, wherein the operations comprise:
alternating between selecting the first set of planes and selecting the second set of planes for being programmed in response to each subsequent request associated with the block stripe.

8. The system of claim 1, wherein the first portion of the set of memory components comprises a set of planes of a quantity of planes, and wherein the operations comprise:
selecting a target PEC for the set of memory components; and
forming the set of planes as a function of the target PEC, the quantity of planes, the first lifetime PEC of the first portion, and the second lifetime PEC of the second portion.

9. The system of claim 8, wherein the set of planes is formed in accordance with the function comprising:
$$set of planes count = PC * \frac{PEC of the first portion - the target PEC}{PEC of the second portion - the target PEC} ,$$
where the set of planes count represents how many planes are in the set of planes, PC corresponds to the quantity of planes, the PEC of the first portion corresponds to the first lifetime PEC, and the PEC of the second portion corresponds to the second lifetime PEC.

10. The system of claim 1, wherein the operations comprise:
reducing the first lifetime PEC at a different rate than the second lifetime PEC in response to the first and second requests.

11. The system of claim 1, wherein the operations comprise:
selecting a plane count associated with the first portion; and
computing, based on the plane count, a target PEC representing a remaining quantity of PEC of the first and second portions after completing balancing the first lifetime PEC with the second lifetime PEC.

12. The system of claim 11, wherein the target PEC is computed in accordance with:
$$target PEC = \frac{\begin{matrix}PEC of first portion * Total Plane Count - \\ PEC of second portion * Plane Count Selected\end{matrix}}{Total Plane Count - Plane Count} ,$$
where the PEC of the first portion corresponds to the first lifetime PEC, the PEC of the second portion corresponds to the second lifetime PEC, and the total plane count represents a quantity of planes in a memory die comprising the first portion.

13. The system of claim 1, wherein the operations comprise:
selecting a target PEC for the set of memory components;
computing a plurality of quantities of planes to select from a set of planes of each memory die of a plurality of memory dies as a function of the target PEC, a total quantity of planes in the set of planes, the first lifetime PEC of the first portion, and the second lifetime PEC of the second portion;
determining a scaling factor for each of the plurality of quantities of planes; and
generating a plurality of plane selection tables based on the plurality of quantities of planes and the scaling factors, a first plane selection table of the plurality of plane selection tables corresponding to a first memory die of the plurality of memory dies, a second plane selection table of the plurality of plane selection tables corresponding to a second memory die of the plurality of memory dies.

14. The system of claim 13, wherein:
the first plane selection table comprises a first list of sequential times corresponding to the scaling factor of a first quantity of the plurality of quantities, each sequential time in the first list of sequential times being associated with identifiers of the planes selected from the set of planes of the first memory die; and
the second plane selection table comprises a second list of sequential times corresponding to the scaling factor of a second quantity of the plurality of quantities, each sequential time in the second list of sequential times being associated with identifiers of the planes selected from the set of planes of the second memory die, the first and second lists of sequential times having different quantities of sequential times.

15. The system of claim 14, wherein the operations comprise:
obtaining a current PEC associated with the second portion of the set of memory components;
dividing the current PEC by the scaling factor of the first quantity of the plurality of quantities of the first die to identify a remainder; and
identifying an individual sequential time within the first plane selection table corresponding to the remainder.

16. The system of claim 15, wherein the operations comprise:
retrieving the identifiers of the planes selected from the set of planes of the first memory die corresponding to the individual sequential time; and
performing the first memory operation on a first subset of planes of the first memory die corresponding to the retrieved identifiers of the planes selected from the set of planes without performing the first memory operation on a second subset of planes of the first memory die.

17. The system of claim 1, wherein the operations comprise:
determining that a first current PEC of the first portion corresponds to a second current PEC of the second portion; and
in response to determining that the first current PEC corresponds to the second current PEC, discontinuing balancing of the first lifetime PEC with the second lifetime PEC.

18. The system of claim 17, wherein discontinuing balancing comprises performing each of a plurality of memory operations received after the first current PEC corresponds to the second current PEC on the first and second portions of the set of memory components.

19. A computerized method comprising:
determining that a first lifetime program-erase count (PEC) of a first portion of a set of memory components is smaller than a second lifetime PEC of a second portion of the set of memory components;
performing a first memory operation on the first and second portions of the set of memory components in response to a first request associated with a block stripe comprising the set of memory components;
erasing the block stripe comprising the first and second portions of the set of memory components after performing the first memory operation; and
after erasing the block stripe, performing a second memory operation on the second portion of the set of memory components without performing the second memory operation on the first portion of the set of memory components in response to a second request associated with the block stripe.

20. A non-transitory computer-readable storage medium comprising instructions that, when executed by a processing device, cause the processing device to perform operations comprising:
determining that a first lifetime program-erase count (PEC) of a first portion of a set of memory components is smaller than a second lifetime PEC of a second portion of the set of memory components;
performing a first memory operation on the first and second portions of the set of memory components in response to a first request associated with a block stripe comprising the set of memory components:
erasing the block stripe comprising the first and second portions of the set of memory components after performing the first memory operation; and
after erasing the block stripe, performing a second memory operation on the second portion of the set of memory components without performing the second memory operation on the first portion of the set of memory components in response to a second request associated with the block stripe.
